(19) United States
(12) Patent Application Publication
(10) Pub. No.: US 2009/0274289 A1
(43) Pub. Date: Nov. 5, 2009

(54) METHOD AND A SYSTEM FOR ACQUIRING CALLING PARTY FEEDBACK

(75) Inventor: Kasper Bloch, Charlottenlund (DK)

Correspondence Address: BACON & THOMAS, PLLC, 625 SLATERS LANE, FOURTH FLOOR, ALEXANDRIA, VA, 22314-1176, US

(73) Assignee: Telefaction A/S, Frederiksberg (DK)

(21) Appl. No.: 12/296,638

(22) PCT Filed: Apr. 10, 2006
(86) PCT No.: PCT/DK2006/000203

§ 371 Date: Feb. 2, 2009

(51) Int. Cl. H04M 3/00

(52) U.S. Cl. 379/265.06

(57) ABSTRACT

The invention relates to a survey system SS comprising
a survey system input SSI for input of call descriptive data CDD from a local switch LS,
interviewing means IN providing feedback from calling parties CPF routed through said local switch LS,
correlation means CM producing correlation results CR on the basis of correlating said call descriptive data CDD and said calling party feedback CPF.

According to the invention, a survey system is provided which may be applied for obtaining feedback from users of a service provider via a local switch.

### FIELD OF THE INVENTION

The invention relates to a system for acquiring feedback from calling parties according to claim 1.

### BACKGROUND OF THE INVENTION

The invention relates to a system for acquiring feedback from calling parties e.g. in connection with call centers or other relevant customer support or service providing. In particular the invention is dealing with evaluation of the experience of a calling party when he/she seeks support or advice in a call center or a telephone-based support system.

Systems for this purpose are well known and may be applied for many different purposes such as obtaining interviews with customers who have contacted a service attendant to order or obtain some kind of support.

The experience of the service may vary significantly depending on how long the calling party is parked in a queue, how many times the call was redirected through the process and the service provided. Evaluation of such systems may be performed in several different ways.

One approach has been followed in the prior art by integrating different hardware- or software-based interviews providing facilities into the telephone system of the individual company. Such systems are extremely expensive as a complete integration of such services into a local telephone system such as a PBX represents a technically very complex solution both with respect to design and maintenance.

An alternative approach is disclosed in US patent application No. 2003/0182135 disclosing a system for performing customer satisfaction surveys.

This system is based on a conventional PBX (PBX: Private Branch Exchange) which again services e.g. call centers via a CTI (CTI: Computer Telephony Integration). A CTI is typically very expensive and may sometimes represent a technical solution which introduces instability into the telephone system.

Thus, systems for acquiring a subset of calling party feedback and for construction of customer satisfaction surveys, typically rely on expensive and complex telephone equipment e.g. PBX's, CTI's etc., which only are feasible for large companies or centralized call centers.

### SUMMARY OF THE INVENTION

The invention relates to a survey system SS comprising
a survey system input SSI for input of call descriptive data CDD from a local switch LS,
interviewing means IM providing feedback from calling parties CPF routed through said local switch LS,
correlation means CM producing correlation results CR on the basis of correlating said call descriptive data CDD and said calling party feedback CPF.

According to the invention, a survey system is provided which may be applied for obtaining feedback from users of a service provider via a local switch.

Call descriptive data CDD is received through a survey system input SSI which may e.g. be a cordless or a galvanic connection.

The term “from” is to be understood that the data may be derived from the local switch or may be received directly from the local switch. An example of call descriptive data derived from the local switch may be if the call descriptive data is established on the basis of signaling to or from the local switch.

An advantageous feature of the system is the plug-and-play feature implying that a survey system may be applied as a plug-in, which may be connected to an existing local switch of a company without any need for integration. Thus, the system according to the invention may be applied as a survey system which is moreover robust compared to conventional systems in the sense that the switching by the local switch is performed by the local switch alone. In other words, a breakdown or functional disorder of the survey system merely results in a temporary pause in the obtaining of calling party feedback CPF and no functional disorder is introduced into the switch. No users of the system will experience annoying breakdowns as routing is performed as usual.

A further advantage of the system is that maintenance of the survey system may be performed independent of the local switch and thereby avoiding that the local switch must be shut down during maintenance. Such maintenance may include maintenance of automated interviewing means, modifications of the setup, maintenance of the monitoring means, which decodes and logs the incoming calls through the local switch, and also maintenance of the system which is used for correlating the obtained interviews with the obtained logs.

The system moreover benefits from the fact that it may work together with local switches applying proprietor signaling schemes.

According to an embodiment of the invention, calling party feedback may e.g. comprise customer satisfaction information, consumer surveys and other marketing surveys.

A system, according to the invention, moreover benefits from the fact that the system is dynamic in the sense that call descriptive data obtained on the basis of call descriptive data exported from the local switch may in fact be expanded to the complete system without any redesign of the local switch even if the recipients are not a part of e.g. a call center. This means that maintenance of the local switch in practice may be performed independent of the added survey system, but it also means that the survey system in practice in a simple way may be modified to cover in principle all recipients covered by the local switch.

In an embodiment of the invention, said correlation results CR comprise customer satisfaction data produced on the basis of a correlation of said call descriptive data CDD and calling party feedback CPF.

In an embodiment of the invention, said correlation results CR comprise information about the routing of the call held together with a caller's evaluation and satisfaction level of the calling experience.

In an embodiment of the invention, said correlation results CR comprise the subjective impression of a calling party compared to factual data of the call.

According to a preferred embodiment of the invention, the factual data of the call and call descriptive data may comprise information of the routing of the call in the system. Call descriptive data may thus e.g. comprise information about for how long the calling party has been waiting in queues, how many times the calling party has been redirected, information about which agents, recipients or which department of the call center has answered the call etc. This information may be correlated with an evaluation of the call, e.g. in the form of an interactive interview performed by the interviewing means, made by the current calling party to produce correlation results. The correlation results can hereby be utilized by the company or e.g. an analysis institute or research center to provide customer satisfaction information. Moreover the information call be utilized in terms of working out and changing service or marketing strategies in the company. Therefore it is determined that correlation results may constitute a very important business improvement.

Factual data of the call may e.g. comprise call descriptive data.

In an embodiment of the invention, said survey system SS is a single unit.

According to a preferred embodiment of the invention, said survey system SS is a single plug-and-play system which is connectable to an existing local switch LS.

In an embodiment of the invention, the wiring of said survey system SS can be established with little or no modification.

In an embodiment of the invention, said survey system SS comprises two or several units.

In an embodiment of the invention, said survey system SS comprises one or several elements physically distributed.

In an embodiment of the invention, said survey system SS is a stand-alone arrangement.

In an embodiment of the invention, an incoming call IC is coupled to said interviewing means to produce said calling party feedback CPF.

In an embodiment of the invention, said interviewing means IM performs an interactive interview without controlling the routing of the local switch. According to a preferred embodiment of the invention, the established interviewing means are applied for the purpose of obtaining information about the routing of the incoming call, and moreover to facilitate that the information may be correlated with feedback obtained from the calling party. The information should preferably be obtained by a stand-alone or plug-in like system or device communicating with conventional local switches such as PBX, IP PBX, PBX including CTI, etc. which control the routing of the incoming calls. In other words, the invention benefits from the fact that existing local switches may be applied according to usual practice with the normal full functionality whereas the information is gained without interfering with the control of the routing in the local switch. Several benefits may moreover be obtained due to this fact as a breakdown of the interviewing means does not affect the ability of the system to route incoming calls properly, contrary to prior art interviewing means which require control of the routing.

In an embodiment of the invention, said interviewing means IM can be situated at the upstream or the downstream with respect to said local switch LS.

According to a preferred embodiment of the invention, the interviewing means IM is situated within the survey system SS, but it may also be found in the upstream of the local switch LS. It is furthermore possible that the interviewing means IM comprises a recruitment arrangement to select a subset of the callers for interviews.

In an embodiment of the invention, said interviewing means is situated externally with respect to the local switch LS.

In an embodiment of the invention, said interviewing means comprises an IVR (IVR; interactive voice response).

In an embodiment of the invention, said IVR is a communication device that provides interactive menus for calling parties CP and obtains calling party feedback CPF on the basis of answers from calling parties CP using a touch-tone telephone keypad.

In an embodiment of the invention, said interviewing means performs an interactive interview prior to hang-up.

In an embodiment of the invention, said interactive interview is performed on the basis of touch-tone data.

In an embodiment of the invention, said interactive interview is performed as a vocal interview.

In an embodiment of the invention, said interactive interview is performed automatically according to at least one predetermined algorithm.

The predetermined algorithm may e.g. imply a pre-processing by which a calling party is identified uniquely or as a part of a group which is interviewed in a certain way whereas others are interviewed in another way. The algorithm may moreover adapt the questions to the calling party in order to obtain an effective and beneficial communication with the calling party.

In an embodiment of the invention, said call descriptive data CDD comprise information of the complete routing through the system.

According to an embodiment of the invention, complete routing may be understood as description of all the routing information relevant to the performed evaluation. In one embodiment it is only necessary to determine the physical endpoint of the call. In an advantageous embodiment of the invention, the system performs a post processing, comprising a pairing of the given physical endpoint and information of which local recipient was operating the physical endpoint at the given time.

In an embodiment of the invention, said call descriptive data CDD comprise data extracted from CDR records.

Typically, call descriptive data from a data logging port of a local switch represent partial call descriptive data which must be post-processed in order to establish the necessary relation between incoming call and the obtained interview. This will be described in more detail subsequently.

In an embodiment of the invention, said call descriptive data CDD are generated on the basis of signaling within the local switch.

In an embodiment of the invention, said call descriptive data CDD comprise identification of a recipient (LR1-LRn) of the incoming call IC.

According to a preferred embodiment of the invention, the call descriptive data comprise information about the routing in the local telephone system. This information regards e.g. distribution of the incoming call in the Automatic Call Distribution ACD, number of recipients the incoming call attends, waiting time in queue, length of call, interfacing of controls signals between the switch and the system components, etc.

In an embodiment of the invention, said call descriptive data CDD is stored in at least one data storage SM.

The call descriptive data may preferably be electrically represented as electrical signals and the processing of call descriptive data CDD may preferably be performed automatically.

In an embodiment of the invention, said survey system further comprises or interacts with a recruiting arrangement RA.

The recruiting arrangement may advantageously be performed automatically in an electrical signal processing circuitry.

In an embodiment of the invention, said recruiting arrangement RA is recruiting a subset of the incoming calls RIC to said survey system SS.

In a preferred embodiment of the invention, the recruiting arrangement may comprise means for selecting calls according to a predetermined selection algorithm which may e.g. recruit one of ten incoming calls to be measured by the interviewing means. Said selection algorithm may change during time, and may e.g. select 10% of the incoming calls in the morning and 20% of the incoming calls in the afternoon.

In another preferred embodiment, the recruiting arrangement may be differentiated upon factors as e.g. geography, call frequency, blacklisted numbers or information earlier collected about the calling party. Said earlier collected information about the calling party may be social status, buyer behavior or other information logged from earlier calls.

In an embodiment of the invention, said recruiting arrangement RA is implemented by means of a hunt group in a local switch LS.

In an embodiment of the invention, said recruiting arrangement RA is implemented by means of a CTI (CTI: Computer Telephony Integration) in or associated to a local switch LS.

According to an embodiment of the invention, the recruiting arrangement may be implemented by means of a hunt group in a local switch comprising a sequential hunting predetermined to route a subset of incoming calls to the survey system according to said predetermined selection algorithm.

In an embodiment of the invention, said recruiting arrangement RA is comprised in the local switch LS.

In an embodiment of the invention, said recruiting arrangement RA is arranged as a gateway upstream to said local switch LS.

In an embodiment of the invention, said recruiting arrangement RA is situated at the telecommunication service provider TSP.

In an embodiment of the invention, said system detects a recruited incoming call RIC from a calling party CP to a local recipient LR via a local switch LS and establishes a further call FC via the local switch to said local recipient LR and connects said further call FC to said recruited incoming call RIC to establish a call from the calling party CP to the recipient.

By establishing a further call, initiated by the survey system, two advantages are obtained, namely a possibility of both monitoring the routing from the local switch to the recipient and utilizing the routing means of the local switch. In other words, a further call is established by means of a local switch thereby realizing the resulting routing by the routing means but also obtaining an easy access to call descriptive data in the local switch related to the specific call. In other words, the interviewing means establishes a further call which is completely controlled in and by the hardware of the local switch according to usual routing algorithms.

Thus, the establishment of a further call may be done in order to be able to utilize partial or incomplete call descriptive data from the local switch.

It should be noted that a recruited call determines that an incoming call intentionally is routed to the interviewing means in the sense that the recruited call either may be a call selected according to an automatic performed algorithm or simply selected on the basis of the predetermination that all incoming calls are regarded as recruited.

In an embodiment of the invention, said recruited incoming call RIC is a subset of all incoming calls to said local switch LS.

In an embodiment of the invention, said further call FC and said recruited incoming IC call are connected exclusively with regard to electrically representative sound.

According to a further aspect of an embodiment of the invention, an incoming call is not just redirected. A new further call FC is established and the voice signals of the incoming call IC and the further call FC are coupled. Thereby, the routing of the further call may be invoked and controlled by the survey system externally to the local switch. This feature enables e.g. establishment of interviews externally to the local switch.

In an embodiment of the invention, said further call FC identifies the calling party CP.

One way of identifying a calling party in the further call is by transferring the identity of the calling party to the further call from the incoming call. Such transferring may e.g. be performed by transferring of a so-called A-number from the incoming call to the further call. By transferring the A-number in a preferred embodiment of the invention means that the interviewing means are hidden by the A-number from the calling party. The recipient thereby handles the call as if it was not measured.

In an embodiment of the invention, a relation is established between calling party feedback and call descriptive data by said further call FC.

In an embodiment of the invention, said further call FC is controlled by means in the survey system SS.

In an embodiment of the invention session data is established on the basis of said further call FC by the survey system SS and stored as partial or complete call descriptive data CDD.

According to an embodiment of the invention, the further call may be established to obtain the necessary call descriptive data.

In an embodiment of the invention, said further call FC provides call descriptive data CDD on the basis of signaling in the local switch LS.

In an embodiment of the invention, said recruited incoming call RIC is forwarded to interviewing means IM upon termination of said further call FC.

According to an embodiment of the invention, the termination of the further call is understood to be the time where the user enters the interviewing phase of the call, i.e. when the relevant services have been provided by the relevant local recipient.

In an embodiment of the invention, said survey system SS establishes session data representing said further call FC.

The measurement of the further call FC within the survey system SS, session data, is a very advantageous feature within the scope of the invention. This information may be used by the correlation means CM, to perform a matching as a part of the correlation process.

In an embodiment of the invention, said survey system SS establishes call descriptive data CDD by matching of partial call descriptive data CDD exported by said local switch LS and further partial call descriptive data relating to the corresponding further call FC.

A part of the correlation process is to establish or obtain call descriptive data which may be related to the obtained interviews even if no explicit relation exists.

According to an advantageous feature of the invention, call descriptive data for use in the correlation process of correlating obtained interview data with the relevant calls, may be “pieced” together from different partial call descriptive data. This is in particular advantageous when a direct correlation between obtained interviews and the relevant call descriptive data is impossible due to the fact that no explicit information binds the interview and the call descriptive data together. This piecing together allows the system to rely on information such as exported CDR records which per se do not comprise any explicit relation to the obtained interviews.

In an embodiment of the invention, said survey system SS establishes call descriptive data CUD by matching of partial call descriptive data CDD, preferably CDR records exported by said local switch LS and further partial call descriptive data relating to the corresponding further call FC as a part of a correlation process to produce correlation results CR.

In an embodiment of the invention, said correlation result CR is established on the basis of said correlation means which includes a matching process that performs a matching of said call descriptive data CDD, received in said survey system input SSI, and said session data.

The matching may utilize identifiers available and suitable for the purpose.

In an embodiment of the invention, said matching involves a comparison of the duration of calls measured in the survey system SS and measured on the basis of data obtained by the local switch LS.

The measurement of the duration of calls through the local switch may be applied to recognize a call established upstream to the local switch in the partial call descriptive data exported from the local switch. Such recognition and correlation may thus be obtained by comparing the length of the call established in the survey with the length of, at this stage, an unrecognized call derived and exported from the local switch.

In an embodiment of the invention, said matching involves determination of a time delta designating the expected time offset in the local switch LS with respect to the survey system SS.

Thus, a time delta may advantageously be utilized for the purpose of recognizing an incoming call, typically a further call, in the partial call descriptive data exported or obtained from the local switch.

In an embodiment of the invention, said matching involves attaching a unique identifier to the call when the call is coupled through the survey system SS.

In an embodiment of the invention, said correlation means CM performs a correlation as a batch processing on call descriptive data CDD and calling party feedback CPF obtained and stored over a period.

In an embodiment of the invention, said correlation means CM performs a correlation as a batch processing on call descriptive data CDD and calling party feedback CPF obtained and stored over a period and wherein said period is at least 5 minutes.

In an embodiment of the invention, said correlation means CM performs a correlation as a batch processing on call descriptive data CDD and calling party feedback CPF obtained and stored over a period and wherein said period is at least 30 minutes.

In an embodiment of the invention, said correlation means CM performs a correlation as a batch processing on call descriptive data CDD and calling party feedback CPF obtained and stored over a period and wherein said period is at least 1 hour.

In an embodiment of the invention, said correlation means CM performs a correlation as a batch processing on call descriptive data CDD and calling party feedback CPF obtained and stored over a period and wherein said period is at least 6 hours.

In an embodiment of the invention, said correlation means CM performs a correlation as a batch processing on call descriptive data CDD and calling party feedback CPF obtained and stored over a period and wherein said period is at least 24 hours.

In an embodiment of the invention, said system further comprises an exporting arrangement EA exporting call descriptive data CDD from said local switch LS to said survey system SS.

In an embodiment of the invention, said call descriptive data CDD is exported from said local switch LS to said survey system SS via said exporting arrangement EA.

In an embodiment of the invention, said exporting arrangement EA comprises exporting of call descriptive data retrieved from CDR records.

In an embodiment of the invention, said exporting arrangement EA comprises export of call descriptive data CDD obtained on the basis of signaling within the local switch.

In an embodiment of the invention, said exporting arrangement EA is exporting call descriptive data CDD without interfering with the local switch.

Furthermore, the invention relates to a system for acquiring feedback CPF from a calling party. The system comprises
a survey system SS according to any of the claims 1-58,
   said system further comprises
a local switch LS routing incoming call IC from a calling party CP to one or more recipients (LR1, LR2, LR3, . . . LRn).

In an advantageous embodiment of the invention, a local switch such as a PBX may simply be regarded as a black-box in the sense that a complete knowledge of the signaling and event scheme is not required in order to obtain the desired call descriptive data. Thus, simple “recordings” of the event schemes related to the call descriptive data of interest may be obtained by performing the routings of interest and then detecting the resulting signaling or patterns in the signaling. This may be advantageous as existing state-of-the-art systems require detailed information, which may be non-available in proprietor systems, related to the setup of the switch, whether the system applies a conventional switch or whether a dedicated so-called CTI is applied for the purpose due to the fact that all routing to be monitored must be routed through the switch.

In an embodiment of the invention, the routing of said incoming call IC to one or more recipients (LR1, LR2, LR3, . . . LRn) in said system is performed by means of said local switch LS.

In an embodiment of the invention, said local switch LS comprises one PBX (Private Branch Exchange).

In an embodiment of the invention, said local switch LS comprises one CTI (Computer Telephony integration).

In an embodiment of the invention, said local switch LS comprises one IPPBX (Internet Protocol Private Branch eXchange).

In an embodiment of the invention, said one or more recipients (LR1, LR2, LR3, . . . , LRn) comprise at least one customer service representative.

In an embodiment of the invention, said one or more recipients (LR1, LR2, LR3, . . . , LRn) are connected to said local switch LS via a communication network CN.

In an embodiment of the invention, said communication network CN comprises a circuit switched network as PSTN (Public Switched Telephone Network).

In an embodiment of the invention, said communication network CN comprises a packet-based digital network.

According to an embodiment of the invention, one or more of the recipients are customer service representatives. Said customer service representatives may e.g. be evaluated on e.g. customer handling, if they are customer-minded and on whether customer problems were solved, etc.

In an embodiment of the invention, said one or more recipients (LR1, LR2, LR3, . . . , LRn) comprise at least one customer service representative of a company sphere CS.

According to an embodiment of the invention, the company sphere, such as a call center, comprises one or more recipients which collect a subset of incoming calls.

Furthermore, the call center may be distributed, centralized or outsourced. If distributed, call centers may route incoming calls between the recipients in the different call center. The call center could preferable also be an internal department in the firm, which handles a subset of the incoming calls.

The call center(s) may be located at the premises or in the vicinity of the local switch or they may be distributed.

In an embodiment of the invention, said local switch comprises said PBX and wherein the PBX is adapted for distribution of packet-based communication alone or in combination with circuit switched combination.

Furthermore, the invention relates to a method of acquiring obtained feedback from a calling party in a system comprising:
a local switch LS routing incoming call IC from a calling party CP to one or more recipients (LR1, LR2, LR3, . . . , LRn),
interviewing means IM obtaining a feedback CPF from a calling party on the basis of an interactive interview with said calling party CP,
   said method comprising the steps of
exporting call descriptive data CDD from said local switch LS describing calls routed through said local switch LS and
   correlating said feedback CPF with said call descriptive data CDD into correlation results CR.

In an embodiment of the invention, said feedback CPF is stored in at least one data storage SM.

In an embodiment of the invention, said correlation results CR are stored in at least one data storage SM.

In an embodiment of the invention, said correlation results CR comprise satisfaction level data obtained from said calling party.

In an embodiment of the invention, said correlation results CR are obtained externally with respect to said local switch LS.

Furthermore, the invention relates to a use of call descriptive data CDD exported from a local switch LS for establishment of correlation results CR on the basis of a correlation between calling party feedback CPF and said call descriptive data CDD.

Furthermore, the invention relates to a use of call descriptive data CDD exported from a local switch LS for establishment of correlation results CR on the basis of a correlation between calling party feedback CPF and said call descriptive data CDD in a system according to any of the claims 1-58.

### THE DRAWINGS

The invention will now be described with reference to the drawings of which

FIG. 1 illustrates the basic principles of a preferred embodiment of a system for acquiring feedback from a calling party.

FIG. 2 illustrates a flowchart of a basic calling flow.

FIG. 3 illustrates another preferable embodiment of the system for acquiring feedback from a calling party.

FIG. 4 illustrates a detailed view of a non-limiting survey system and the elements within.

FIG. 5 illustrates another basic principle of a local switch.

FIGS. 6-9 illustrate other preferred embodiments of the invention.

FIG. 10 illustrates a flowchart of a basic preferred incoming call handling procedure with recruiting.

FIGS. 11-12 illustrate other flowcharts of more detailed call handling in a preferred embodiment.

FIG. 13 illustrates another embodiment of the invention.

### DETAILED DESCRIPTION

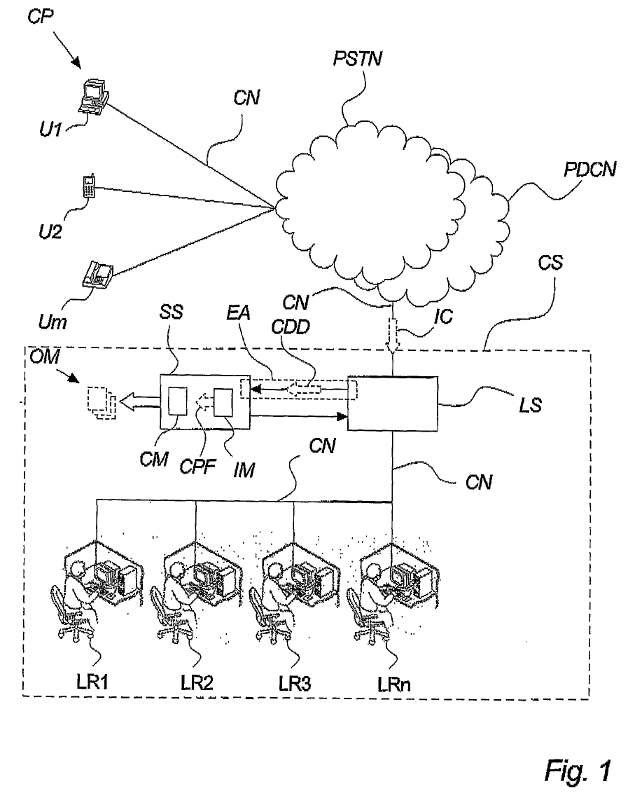

FIG. 1 illustrates a system for acquiring calling party feedback CPF. The system illustrates one non-limiting embodiment of the invention. The system comprises a PSTN (PSTN: Public Switched Telecommunication Network), PDCN (PDCN: Public Data Communication Network), one or more users U1, U2, Um, a local switch LS, a survey system SS, one or more recipients LR1, LR2, LR3, LRn, and exporting arrangements EA for exporting call descriptive data CDD. Furthermore, the survey system SS may comprise correlating means CM, interviewing means N and their may be one or more output means OM.

The users U1, U2, Um are bi-directionally connected to the PSTN or e.g. PCDN through a communication network CN. The communication network CN furthermore connects to the recipients LR1, LR2, LR3, LRn via the local switch LS bi-directionally.

In an alternate embodiment of the invention the users U1, U2, Um are bi-directionally connected to the PCDN e.g. the Internet through a communication network CN. The telephone communication between the user U1, U2, Um and the local switch LS could in one embodiment of the invention comprise the use of Skype or any other suitable telecommunication over PDCN.

The local recipients LR1, LR2, LR3, LRn may e.g. be a call centre of a customer support or any relevant associated service or recipient.

When a user e.g. U1 initiates a call to a recipient within the domain of the local switch he becomes a calling party CP and the call is forwarded to the local switch LS as an incoming call IC via the communication network CN.

The call may now be directed to one or several of the recipients manually or automatically controlled by means of relevant conventionally known provisions by means of the local switch.

The local switch LS is connected to a survey system SS which establishes both call descriptive data CDD and calling party feedback CPF. The call descriptive data CDD typically comprise signaling information or CDR (CDR: Call Detail Record), which may be decoded to the degree necessary for obtaining a sufficient knowledge of the incoming call's way through the system. The call descriptive data CDD or signaling information is in a preferred embodiment obtained by exporting arrangements EA between the local switch LS and the survey system SS.

The survey system SS may further comprise correlating means CM and interviewing means M. The interviewing means IN may in a preferred embodiment, obtain calling party feedback CPF on the basis of an interactive interview with the calling party CP1, CP2, CPn. The interactive interview could e.g. be obtained by an IVR (IVR: Interactive Voice Response unit).

The survey system SS may in a preferred embodiment of the invention obtain information such as calling party feedback CPF correlated with call descriptive data CDD. For further study these correlation results may be exported by output means OM from the survey system SS. The output means may be anything that can receive the correlation result CR and present the output result CR. In one embodiment of the invention the presentation of the output may be a printer, report application, logging file, screen or any other useful connectable things.

The local switch LS may further be connected to one or more local recipients LR1, LR2, LR3, LRn through the communication network CN.

The local communication network CN in the domain or perimeter to the local switch LS typically comprises PTN (PTN: Private Telecommunication network), LAN (LAN: Local Area Network), VoIP (VoIP: Voice over Internet Protocol) or wireless data transfer and comprises both signaling information and voice. Thereby the communication network comprises any suitable network for establishing a telephone communication between a local switch LS and one or more recipients LR1, LR2, LR3, LRn.

The complete system of the local switch and the survey system may be referred to a company sphere CS comprising the company partly or as a hole and might therefore also comprise one or more geographically distributed departments. In one embodiment there may be a local switch LS for each distributed department which may favor the routing of calls in the heterogeneous company sphere CS.

In one embodiment of the invention, an incoming call IC may be routed to and from different departments within the company sphere CS.

### Survey System SS

In a preferred embodiment of the invention the survey system SS may physically be located in the sphere or in the perimeter of the local switch LS. The survey system is bi-directionally connected to the local switch LS.

### Communication Network CN

Reference to a communication network CN in the present context should be understood in the broadest sense as the function of the communication network basically is to facilitate the desired communication between the applied communication apparatus whether these may comprise mobile communication devices, fixed telephones, LAN based communicators, audio/visual communicators, etc.

### Public Switched Telecommunication Network PSTN

In one preferred embodiment of the invention, the users U1, U2, Um are connected to the local switch LS via one or more communication networks, commonly referred to as PSTN. According to the invention, PSTN basically refers to a public network applied for both digital, analogue and hybrid telecommunication networks.

### Public Data Communication Network PDCN

In another embodiment of the invention, the users U1, U2, Um are connected to the local switch LS via the PDCN e.g. the Internet/UMTS/GPRS, etc.

### Local Switch LS

The local switch may e.g. designate a conventional PBX (PBX: Private Branch Exchange) or any local switch which is able to interface incoming calls to an “internal” network of recipients.

PBXs on market often use proprietary digital-line protocols, although some are analog-based.

Functionally, a conventional local switch e.g. PBX performs three main duties:
Establishing connections between the telephone sets of two users, e.g. mapping a dialed number to a physical phone, ensuring the phone isn't already busy.
Maintaining such connections as long as the users require them, i.e. channeling voice signals between the users.
Providing information for accounting purposes, e.g. metering calls.

Presently PBX typically requires dedicated cabling between the PBX and the “internal” recipients although cordless or e.g. LAN-based connections may be applied.

The switching of calls is typically associated to the term events, which designates the system's ability to interface with connected equipment, thereby allowing the PBX to control the routing of calls.

The PBX may typically cover up to e.g. about 50000 calls per hour although this number may vary significantly. The PBX may thus cover relatively large companies and support a large number of functionalities.

Most PBXs provide means for obtaining detailed call information about inbound or outbound calls, e.g. what extensions they have called, time and dates of calls, length of calls and so on. This feature is often referred to as CDR (CDR: Call Detail Record). This reference may vary between the manufacturers but the basic functionality is the same. Generally, the CDR is created at the end of a call but on some phone systems the data is available during the call. CDR is created by gathering call information or events such as connections made through the network, e.g. switches. CDR can be extracted from PBX via a dedicated port, e.g. a serial port, referenced as Station Message Detail Recording SMDR. Call accounting systems utilize SMDR to process call information for costing. Call accounting systems transfer this information and provide detailed, easily readable reports.

The local switch LS may be an analog or digital PBX, PABX, IPBX or other telecommunication switch characterized as a hardware switch or software switch.

The local switch may also represent an analog, a digital switch, a packet-switched switch, e.g. VoIP or hybrids thereof.

A very advantageous feature of the illustrated embodiment of the invention in FIG. 1 is that the desired feedback CPF from the calling party is obtained by using a plug-and-play survey system SS together with the existing telephone equipment, and without compromising or interfering with the functionality of the basic and very important functionality of the local switch.

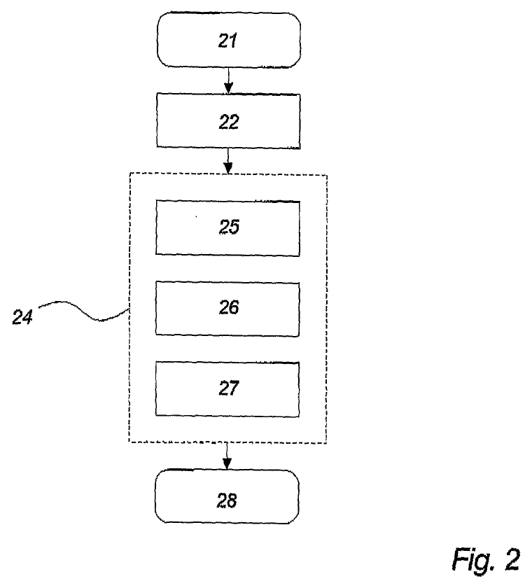

FIG. 2 illustrates a basic non-limiting flowchart of an embodiment of the invention where the incoming call is initiated by the calling party in step 21. Thereby the incoming call IC is detected in step 22 by the local switch LS in the company sphere CS. The present flowchart refers to the system as previously described and explained with reference to FIG. 1. The connection from the calling party CP1, CP2, CPm to the local switch LS may be established as earlier described through a circuit switched network, e.g. PSTN, the packed switched network, e.g. Internet, PDCN, or any suitable network.

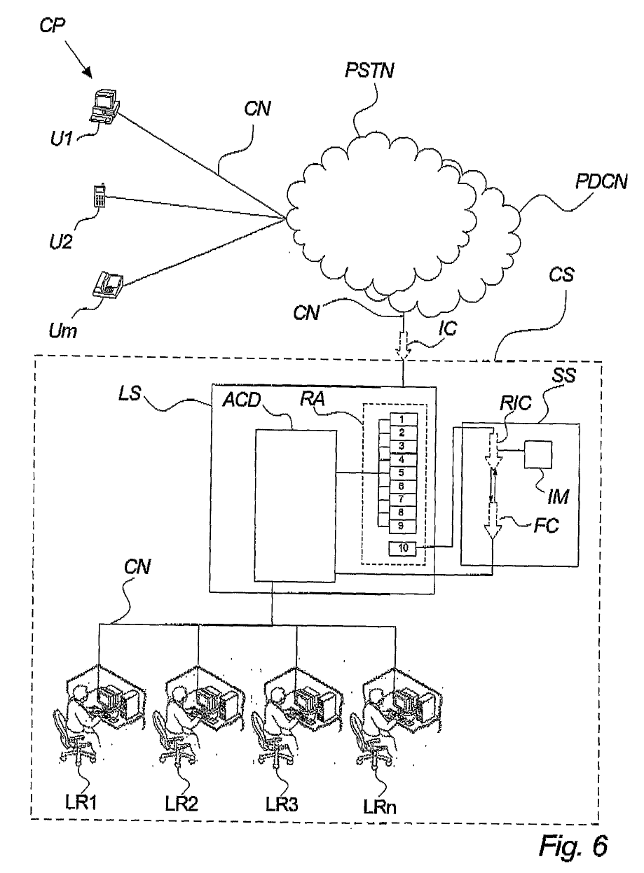

A subset of the incoming calls IC, 22 may in one embodiment of the invention be recruited 24 via a recruitment arrangement RA, subsequently described—particularly with reference to FIGS. 6-9, and applied for obtaining calling party feedback CPF, 26 and the incoming call IC, 22 is routed to the survey system SS. In step 25, call descriptive data CDD is obtained comprising information about routing of the incoming call IC, 23. The call descriptive data CDD, 25 is in a preferred embodiment obtained in temporary storages as e.g. a cache, buffer, memory or other favorable storage equipment. This temporary storage could be in the local switch LS or more likely in the survey system SS.

In one preferred embodiment, the selected subset of the incoming calls IC, 22 may prior to hang-up be routed to interviewing means IM e.g. an IVR for acquiring calling party feedback CPF in step 26.

The calling party feedback CPF, 26 is correlated in step 27 with the call descriptive data CDD, 25 and thereby producing correlation results CR comprising information about customer service level and call descriptive data CDD e.g. waiting times, number of routings of one call, length of call etc.

When the interviewing session is terminated, the call is terminated in step 28.

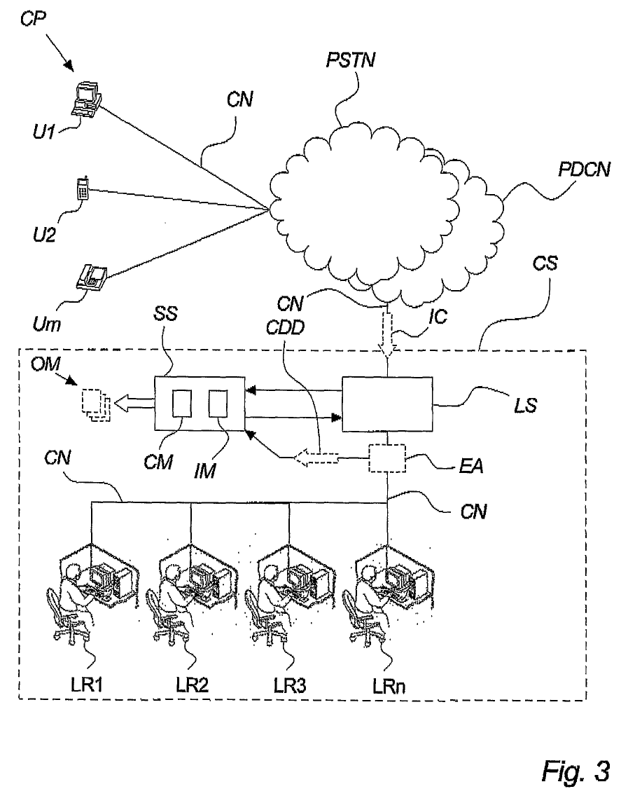

FIG. 3 illustrates a modification of FIG. 1, wherein the exporting arrangement EA is preferably placed in the communication network CN between the local switch LS and one or more local recipients LR1, LR2, LR3, LRn. In this embodiment the exporting arrangement EA obtains call descriptive data CDD entirely from the communication network CN and thereby not egg. CDR data exported from the PBX. The exporting arrangement EA preferably transmits the call descriptive data CDD directly to the survey system SS without interfering with the local switch LS.

In another embodiment, it might be preferred to obtain both call descriptive data CDD from the local switch as e.g. CDR data and combine this information with call descriptive data CDD as signaling from the communication network CN between e.g. local switch LS and a local recipient LR1.

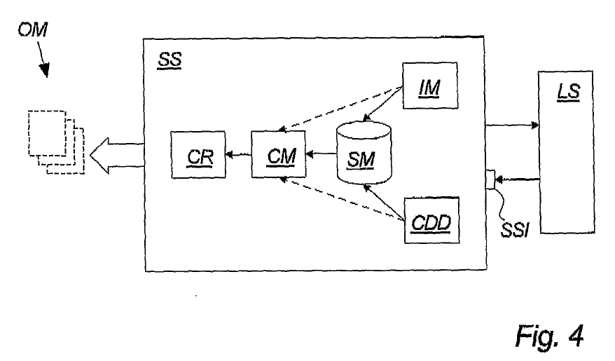

FIG. 4 is a detailed view of a preferred embodiment of the invention illustrating the survey system SS and a subset of the elements in the survey system SS. The survey system SS may comprise interviewing means IM, call descriptive data CDD), storage means SM, correlating means CM producing correlation result CR and one or more output means OM.

In a preferred embodiment of the invention the call descriptive data CDD is obtained from the telephone system e.g. PTN, preferably from the local switch LS or the exporting arrangement EA via a survey system input SSI. The survey system input SSI may e.g. be a cordless or galvanic connection. Furthermore, the survey system may comprise means for presenting the results OM of the correlated result CR in a plurality of ways, e.g. screen, printer, graph, report, logging file etc.

The storage means SM may be connected to both interviewing means IM, call descriptive data CDD and correlation means CM. Thereby the storage SM has the ability to store data for later processing.

It is advantageous in a preferred embodiment of the invention that the retrieval of call descriptive data CDD, retrieval of calling party feedback CPF via interviewing means IM and the correlation CM may be processed in batch and/or real-time.

### Batch Processing

In batch processing the call descriptive data CDD is stored in the storage means SM or preferably in the CDR log in the PBX. The calling party feedback CPF obtained by the interviewing means IM is also obtained in the storage means SM and correlated CM with the call descriptive data CDD as a batch e.g. on an hourly, daily, monthly basis. The correlation batch transmits the data through the output means OM after processing.

### Real-Time Processing

In real-time processing the calling party feedback CPF, obtained by the interviewing means IM, is temporarily stored in the storage means SM. When the incoming call IC is terminated the call descriptive data CDD is temporarily stored in the storage means SM. The calling party feedback CPF and the call descriptive data CDD) is then correlated by the correlation means CM and transmitted through the output means OM in real-time however with a minor time delay.

In another embodiment of the invention, the call descriptive data CDD is retrieved real-time and not at the termination of the call. The real-time call descriptive data CDD may then be stored in the storage means SM and correlated with the calling party feedback CPF when possible.

### Matching

A part of the correlation process is to establish or obtain call descriptive data which may be related to the obtained interviews even if no explicit relation exists.

According to an advantageous feature of the invention, call descriptive data for use in the correlation process of correlating obtained interview data with the relevant calls, may be “pieced” together of different partial call descriptive data. This is in particular advantageous when a direct correlation between obtained interviews and the relevant call descriptive data is impossible due to the fact that no explicit information binds the interview and the call descriptive data together. This piecing together allows the system to rely on information such as exported CDR records which per se do not comprise any explicit relation to the obtained interviews.

The measurement of the further call FC within the survey system SS, session data, is a very advantageous feature within the scope of the invention. This information may be used by the correlation means CM, to perform a matching as a part of the correlation process.

According to one embodiment of the invention, the matching of CDR data in the local switch LS and session data from the corresponding further call FC from the survey system SS may be done as a part of correlating CM said call descriptive data CDD and said calling party feedback CPF. An advantageous method of matching CDR data with session data is described in the following.

Session data from the survey system SS and CDR data are records matched to their corresponding sessions by using the identifiers available. Such identifiers may in the present embodiment be e.g. An A-number, period or it might be a unique identifier attached by the survey system SS or the local switch LS. The matching is in an advantageous embodiment of the invention done by using several identifiers. In table 1 and table 2 the data of the session and the CDR records that matches the session are illustrated.

TABLE 1
Session data from a survey system

| sequence | time | ingoing | board | line | local | remote | name |
|---|---|---|---|---|---|---|---|
| 1 | 2005-10-06 11:19:55 | 1 | 1 | 14 | 2403 | 5477xxxx | incoming offered |
| 2 | 2005-10-06 11:19:55 | 1 | 1 | 14 | 2403 | 5477xxxx | connected |
| 3 | 2005-10-06 11:20:23 | 0 | 1 | 29 | 5477xxxx | 2440 | outgoing ringing |
| 4 | 2005-10-06 11:20:25 | 0 | 1 | 29 | 5477xxxx | 2440 | connected |
| 5 | 2005-10-06 11:22:44 | 0 | 1 | 29 | 5477xxxx | 2440 | disconnected |

TABLE 2
CDR records from a local switch.

| type | origin | origindata1 | origindata2 | termination | terminationdata1 | time | duration | A-num |
|---|---|---|---|---|---|---|---|---|
| Q | A | 000 | 004 | TN | 080B | 2005-10-06 11:12:32 | 0 | 5477xxxx |
| N | A | 000 | 004 | | 602447 | 2005-10-06 11:12:45 | 126 | 5477xxxx |
| Q | A | 000 | 004 | TN | 284E | 2005-10-06 11:12:47 | 14 | 5477xxxx |

The matching in this example is done by comparing the A-numbers of the call. Further it is possible to verify the correctness of the matching on the basis of the measured duration of the call. In the above-illustrated example the duration of the call is measured from the session data by subtracting the timestamp from table 1 row 3 and 5: “2005-10-06 11:20.23” from the timestamp “2005-10-06 11:22:44” which gives a duration of 139 seconds. This is compared with the measured duration of the call in the CDR records, table 2 rows 2 and 4, which are 140. This is a verifying factor despite a one second difference.

In a further embodiment of the invention, the matching of the call may be done by attaching a unique ID in the survey system SS. It is hereby possible to locate the call in the CDR data. The illustrated tables below show an example of using a unique ID to make a matching.

TABLE 3
Session data from a survey system

| sequence | time | ingoing | board | line | local | remote | name | Unique ID |
|---|---|---|---|---|---|---|---|---|
| 1 | 2005-10-06 11:19:55 | 1 | 1 | 14 | 2403 | 5477xxxx | incoming offered | |
| 2 | 2005-10-06 11:19:55 | 1 | 1 | 14 | 2403 | 5477xxxx | connected | |
| 3 | 2005-10-06 11:20:23 | 0 | 1 | 29 | 5477xxxx | 2440 | outgoing ringing | UID1 |
| 4 | 2005-10-06 11:20:25 | 0 | 1 | 29 | 5477xxxx | 2440 | connected | UID1 |
| 5 | 2005-10-06 11:22:44 | 0 | 1 | 29 | 5477xxxx | 2440 | disconnected | UID1 |
| 6 | 2005-10-06 11:31:30 | 0 | 1 | 29 | 2403 | 8610xxxx | incoming offered | |
| 7 | 2005-10-06 11:31:30 | 0 | 1 | 29 | 2403 | 8610xxxx | connected | |
| 8 | 2005-10-06 11:32:13 | 0 | 1 | 29 | 8610xxxx | 2440 | outgoing ringing | UID2 |
| 9 | 2005-10-06 11:32:15 | 0 | 1 | 29 | 8610xxxx | 2440 | connected | UID2 |
| 10 | 2005-10-06 11:33:19 | 0 | 1 | 29 | 8610xxxx | 2440 | disconnected | UID2 |

TABLE 4
CDR records from a local switch with unique identifiers.

| origin | origindata1 | origindata2 | termination | terminationdata1 | terminationdata2 | time | duration | A-num | Unique ID |
|---|---|---|---|---|---|---|---|---|---|
| A | 000 | 004 | TN | 080B | | 06-10-2005 11:12 | 0 | | UID1 |
| A | 000 | 004 | | 602447 | | 06-10-2005 11:12 | 126 | | UID1 |
| A | 000 | 004 | TN | 284E | | 06-10-2005 11:12 | 14 | | UID1 |
| A | 000 | 004 | TN | 123E | | 06-10-2005 11:24 | 0 | | UID2 |
| A | 000 | 004 | TN | 321E | | 06-10-2005 11:24 | 0 | | UID2 |

The matching in this example cannot be done by comparing duration or A-numbers due to lack of the same. Thus, in this embodiment of the invention it is done by attaching a unique ID to the call in the survey system SS. It is seen in the table 3 row 4, 5, 6 and table 4 row 2, 3, 4 that the unique ID is equal.

In a further embodiment of the invention, it is possible to accomplish a match by making a controlled duration of the calls in the survey system SS. This way it is possible to locate a call in the CDR record.

In an advantageous embodiment of the invention, the matching is done by finding a time delta. The time delta is found by finding a pattern in associations between the duration of the calls measured in the CDR record and in the session data in the survey system SS. This embodiment of the invention may e.g. be performed as described in the following:

Given a set of data sessions from the survey system SS and a set of CDR records and knowledge of as many identifiers (search criteria) as possible, an initial pairing is performed, which results in a set of matching CDR records for each session. The time delta between each session and all matching CDR records is calculated and the full set of matching CDR records for all sessions is organized into groups of n-second intervals (ex. 10 seconds). In the set of possible CDR record matches for each session, there is only one true match and if the search criteria is accurate enough there should be approximately one CDR record that has the correct time delta. This means that the n-second interval containing the true time delta should now contain at least as many CDR records as there are sessions. The non-matching CDR records for each session will have more or less random time deltas, distributed evenly over a large interval of approx. 8 hours. In a scenario where there are 100 sessions, spanning 8 hours, and 100 matching CDR records for each session, there will be one 10-second interval that contains at least 100 CDR records and 4799 10-second interval containing a total of approx. 9900 CDR records and about 2-3 CDR records on average.

If the 10-second intervals are sorted in descending order by the number of CDR records, the interval at the top would contain at least 100 CDR records. Statistically it would be extremely unlikely that the 10-second interval at the top does not contain the true time delta and empirical studies show that it does indeed contain the correct time delta.

If it is known that the time delta never exceeds e.g. 30 minutes that can also be a search criterion and would increase the efficiency of the above example approx. 16 times, raising the factor of CDR records in the correct interval vs. the incorrect ones from approx. 50:1 to about 800:1.

In one embodiment of the invention, both session data and CDR records are stored in a database. Here the search can e.g. be expressed as two SQL queries:

SELECT delta AS value FROM #Select the correct interval
(SELECT COUNT(*) as num, #Count the number of CDR
records in each n-second interval
ROUND(TIME_TO_SEC( TIMEDIFF(c.time, s.time))/n)*n AS delta
#Calculate the delta interval
FROM sessions s, cdrrecords c
WHERE s.time BETWEEN “YYYY-MM-DD” AND
(“YYYY-MM-DD” + INTERVAL 1 DAY)
AND c.time BETWEEN “YYYY-MM-DD” AND
(“YYYY-MM-DD” + INTERVAL 1 DAY)
AND (search criteria)
GROUP BY delta #Group the CDR records by delta interval
ORDER BY num DESC #Order the grouped interval so the
one containing most entries is first
LIMIT 1) as t

Note that since the time delta often changes continuously or on a daily basis it is recalculated for each day.

When the correct delta interval has been found it can be used in a second refining query where the true delta value is calculated.

SELECT ROUND(AVG(TIME_TO_SEC( TIMEDIFF(c.time, s.time))))
AS value FROM sessions s, cdrrecords c
WHERE s.time BETWEEN “YYYY-MM-DD” AND
(“YYYY-MM-DD” + INTERVAL 1 DAY)
AND c.time BETWEEN “YYYY-MM-DD” AND
(“YYYY-MM-DD” + INTERVAL 1 DAY)
AND (search criteria)
AND (c.time + INTERVAL delta SECOND)

BETWEEN (s.time − INTERVAL x SECOND) AND

(s.time + INTERVAL x SECOND)

Many modern PBXs comprise means for merging of traditional telecommunications equipment with computers and computer applications referenced CTI. A CTI provides means for e.g. use of a Caller ID to automatically retrieve customer information from a database and display it to the recipient or letting employees dial from their desktop screens by clicking on an icon next to a contact's name in their Microsoft Outlook directory. Furthermore, a CTI typically comprises means for logging information of call statistics, based on which time local recipients have logged in and out of the system. The routing of incoming calls is typically performed by means within the CTI.

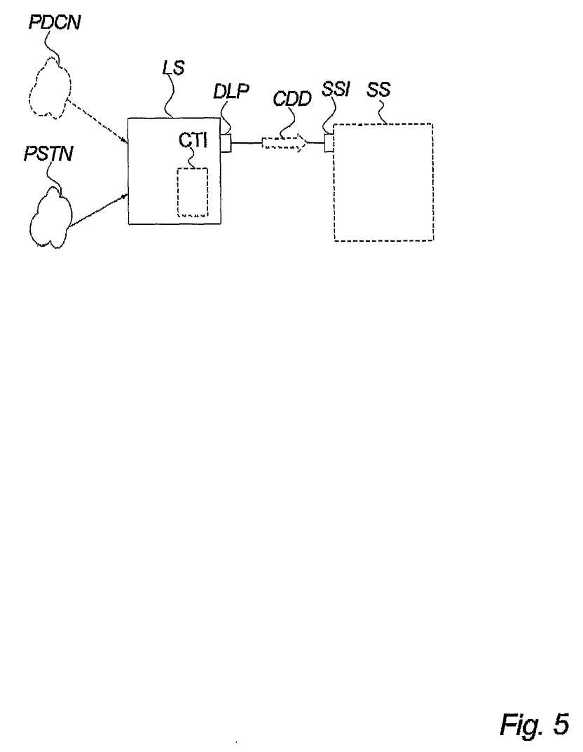

FIG. 5 illustrates one of several different types of applicable local switches within the scope of the invention. The system comprises a PSTN (PSTN: Public Switched Telecommunication Network), a PDCN (PDCN: Public Data Communication Network) a local switch LS, Call Descriptive Data CDD, survey system input SSI, and a survey system SS. Moreover, the local switch LS may in this particular embodiment of the invention comprise a CTI (CTI: Computer Telephone Integration) and a Data Logging Port DLP.

The local switch LS is in this particular embodiment of the invention routes the incoming calls by means of a CTI. The incoming calls may enter via PSTN, PDCN or any audio and/or visual transferring means.

In another embodiment of the invention the local switch LS may comprise other means for routing incoming calls. In low-end systems this may e.g. be a hunt group together with an ACD (ACD: Automatic Call Distribution).

The local switch LS comprises a data logging port DLP which may e.g. be an SMDR port (SMDR: Station Management Detail Recording) and may e.g. be an RS 232 serial communication port. The local switch may in this embodiment of the invention be connected to the survey system SS.

Data that is sent through the data logging port DLP is referenced as call descriptive data CDD. call descriptive data CDD may e.g. be data logs which are often referenced as CDR or call detail records. Call descriptive data CDD is sent to the survey system via survey system input SSI.

Note, however, that in an advantageous embodiment of the invention, call descriptive data CDD refers to more than just CDR. CDD may also refer to call information based on signaling or events within the local switch LS or based on signaling retrieved from an active call in the system.

FIG. 6 illustrates a further embodiment of the system for acquiring calling party feedback CPF. This figure is a modification of FIG. 1, wherein the local switch LS and the Survey System SS is modified to visualize another embodiment of the invention. The local switch LS comprises Recruiting Arrangement RA and the Survey System SS comprises the Incoming Call IC, Interview Means IM and Further Call FC.

By establishing a further call, initiated by the survey system, two advantages are obtained, namely a possibility of both monitoring the routing from the local switch to the recipient and utilizing the routing means of the local switch. In other words, a further call is established by means of a local switch, thereby realizing the resulting routing by the routing means but also obtaining an easy access to call descriptive data in the local switch related to the specific call. In other words, the interviewing means establishes a further call, which is completely controlled in and by the hardware of the local switch according to usual routing algorithms.

Thus, the establishment of a her call may be done in order to be able to utilize partial or incomplete call descriptive data from the local switch.

The Local switch LS comprises recruiting arrangement RA which in this particular embodiment of the invention comprises a hunt group. The recruiting arrangement RA comprises means for recruiting a subset of calls to the survey system SS. The illustrated recruiting arrangement RA may e.g. recruit one out of ten incoming calls IC to the survey system SS and transmit the rest of the incoming calls IC to the one and more local recipients LR1, LR2, LR3, LRn. The distribution of the calls to the local recipients LR1, LR2, LR3, LRn, is in this embodiment of the invention done by means of automatic call distribution ACD.

The recruited incoming call RIC is transmitted to the survey system SS where a further call FC is established. This is transmitted to the local switch LS, and is hereby distributed by the ACD like every other call. A very advantageous feature of the illustrated embodiment of the invention in FIG. 6 is that the incoming call IC and the farther call FC is coupled with regard to audio. When the conversation between the calling party CP and one of the local recipients LR1, LR2, LR3, LRn is ended the further call FC connection is closed. Subsequently the interviewing means IM will make an interview with the calling party CP.

In an advantageous embodiment of the invention, the further call FC is furthermore used to get call descriptive data CDD on the basis of signaling in the PBX.

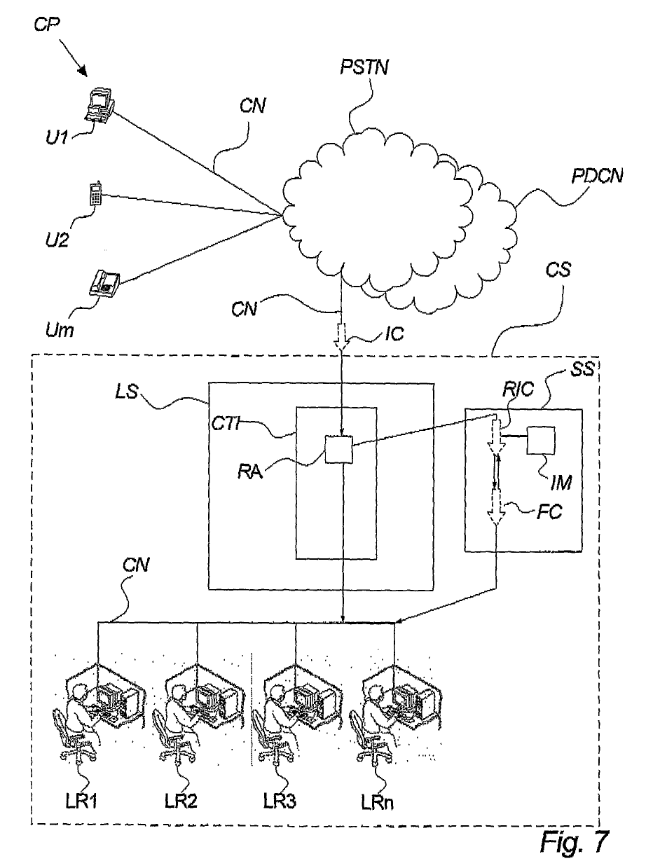

FIG. 7 illustrates another embodiment of the system for acquiring calling party feedback CPF. This figure is a modification of FIG. 6, wherein the content of the local switch LS is modified to visualize another embodiment of the invention.

In this embodiment of the invention, the local switch LS comprises CTI to control routing of the incoming calls IC, The CTI comprises in this embodiment a software-based Routing Arrangement RA.

In this particular embodiment of the invention, with the use of an CTI, it may be possible to retrieve information from the local switch LS about which of the local recipients LR1, LR2, LR3, LRn has been logged into the system and when.

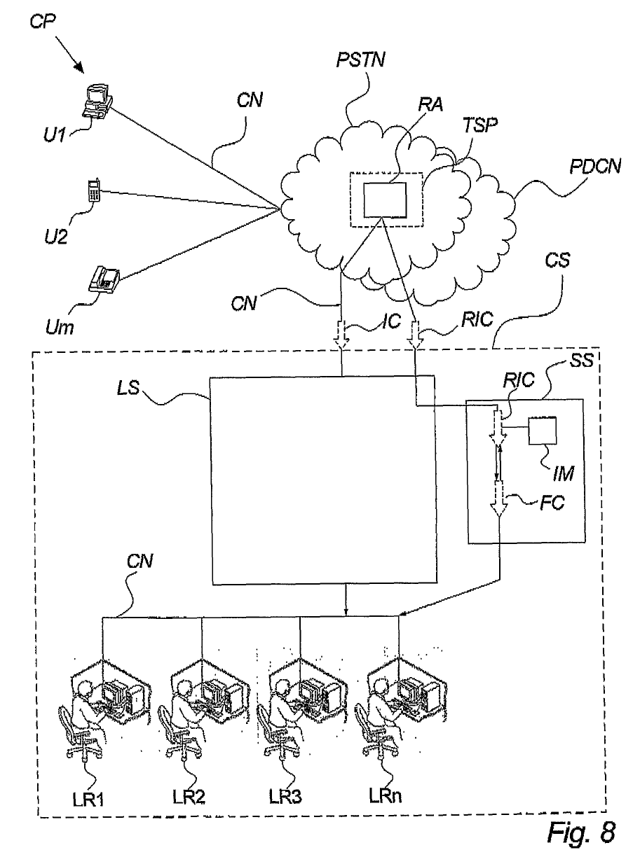

FIG. 8 illustrates a further embodiment of the system for acquiring calling party feedback CPF. This figure is a modification of FIG. 6, wherein the content of the local switch LS is modified to visualize another embodiment of the invention. Furthermore, is the Recruiting Arrangement RA moved outside the company sphere CS and may be located at a telecommunication service provider TSP.

The recruiting arrangement RA is in this particular embodiment of the invention controlled from a remote spot e.g. by the TSP. The recruiting arrangement RA comprises means for recruiting a subset of calls to the survey system SS. The illustrated recruiting arrangement RA may e.g. recruit one out of eight calls referenced as recruited incoming calls RIC to the survey system SS and transmit the rest of the incoming calls IC to the local switch LS. The local switch LS may comprise PBX logic as in FIG. 6, CTI logic as in FIG. 7 or any other switching or routing means.

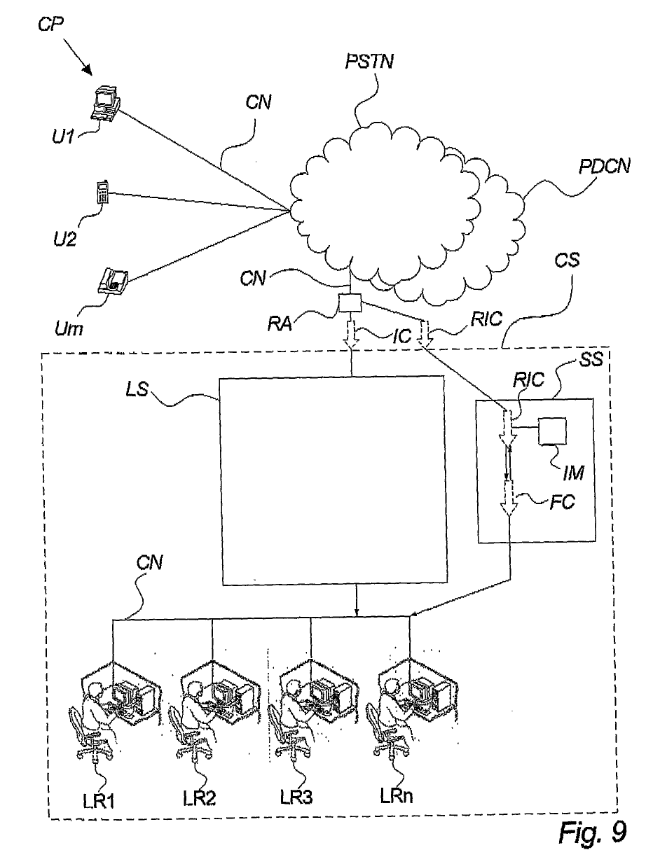

FIG. 9 illustrates a further embodiment of the system for acquiring calling party feedback CPF. This figure is a modification of FIG. 8 wherein the recruiting arrangement RA is situated at the entry point of the survey system SS. In this embodiment the recruiting arrangement functions as a pre-element which is recruiting calls autonomous with respect to the local switch LS.

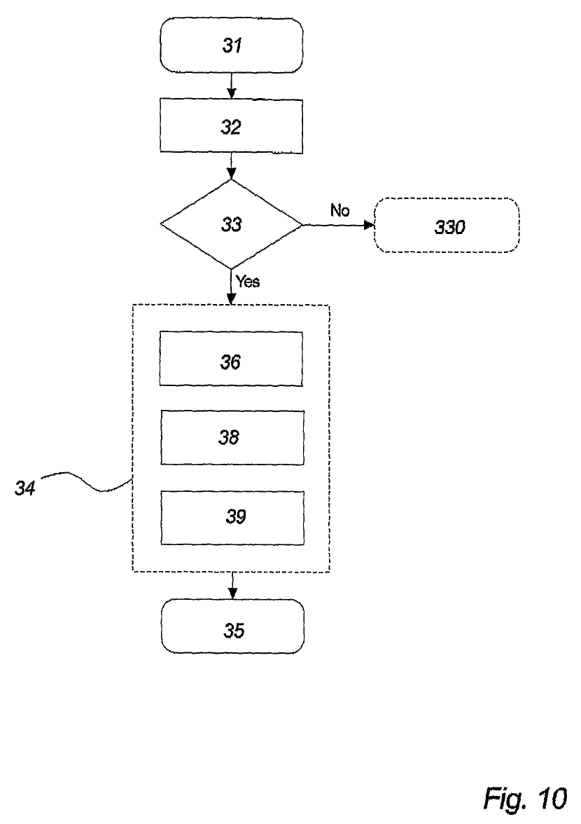

FIG. 10 illustrates a non limiting more detailed flowchart than illustrated in FIG. 2. The incoming call may be initiated by the calling party in step 31. Thereby the incoming call IC is detected in step 32 by the local switch LS in the company sphere Cs.

A subset of these incoming calls IC, 32 may subsequently be recruited 33 by a recruiting arrangement RA and applied for obtaining calling party feedback CPF. In another embodiment of the invention, all incoming calls are recruited. The recruitment of calls may in a preferred embodiment of the invention be carried out using a predetermined algorithm to recruit e.g. a specific part of the calling parties CP or to recruit a predefined percentage of the incoming calls IC. If the calling party rejects to give calling party feedback CPF and thereby also rejects to be measured during the call to the local recipient LR1, LR2, LR3, LRn, the call is moved to step 330, where after the call is sent to the local switch as if the call was not recruited or the call may be further processed as a normal recruited further call FC, without performing the interview.

If the calling party CP accepts the recruitment, the flow moves to step 34 which is characterized by a number of elements to be processed stepwise arbitrarily or simultaneously. These elements comprise call descriptive data CDD, 36, calling party feedback CPF, 38 and correlation means CM, 39. In step 36 call descriptive data CDD is obtained about the routing of the incoming call IC, 32. The call descriptive data CDD, 36 is in a one embodiment obtained in temporary storages as e.g. a cache, buffer, memory or other favorable equipment. This temporary storage could be in the local switch LS or more likely in the survey system SS. Likewise the calling party feedback CPF, 38 is obtained by the interviewing means N and stored in a temporary storage SM.

The call descriptive data CDD, 36 and the calling party feedback CPF, 38 are correlated by the correlating means CM, 39 and thereby providing information about customer service level as well as e.g. waiting times, number of routings of one call, length of call etc.

When the interviewing session is terminated the call is terminated in step 35.

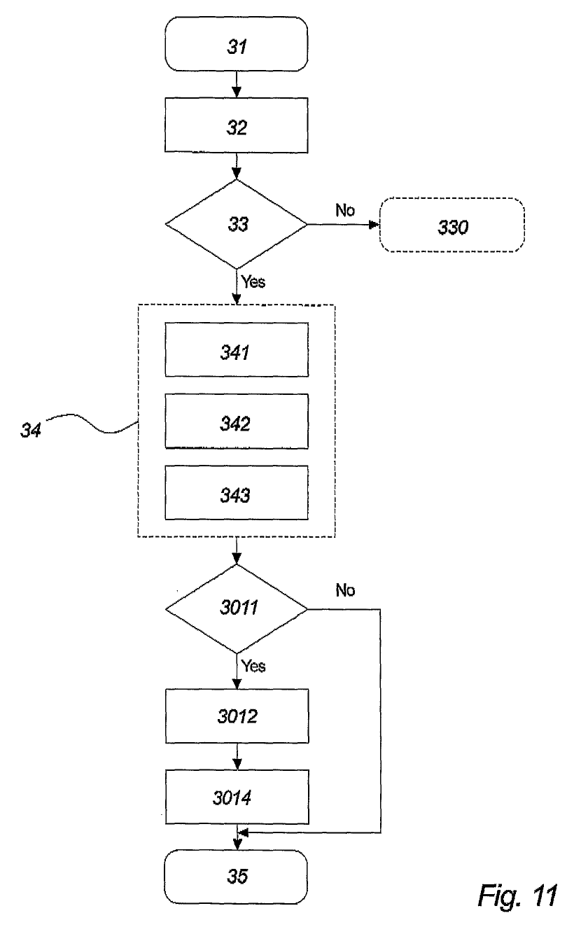

FIG. 11 illustrates a further more detailed flowchart than illustrated in FIG. 10. The initiate steps 31, 32, 33, 330 and 34 are the same as described above but the elements in the recruitment step 34 differ and therefore the rest of the flow will be described below.

When the incoming call is recruited 33 and thereby is a recruited subset of incoming calls 34 a further call FC is established, 341 from the survey system to the local recipient LR1, LR2, LR3, LRn which was the incoming call's IC destination. The voice layer of the further call FC, 341 and the incoming call IC are linked 342 and thereby the local recipient e.g. LR1 is connected through the survey system SS to the calling party CP.

While the calling party CP communicates with one or more local recipients LR1, LR2, LR3, LRn the call descriptive data CDD are measured by the local switch LS and exported via the exporting arrangement EA.

When the local recipient e.g. LR1 hang up and the further call FC, 341 is terminated, the incoming call IC is still active because the incoming call IC and the further call FC, 341 only had the voice layer linked 342.

If the calling party accepts the interview 3011 by maintaining the incoming call connection, the incoming call IC is connected to the interviewing means IM, 3012 which e.g. comprises an IVR (IVR: Interactive Voice Response unit) for acquiring calling party feedback CPF. The interviewing means NM may perform an interactive interview prior to hanging up the further call FC. Said interactive interview may be performed according to at least one predetermined algorithm which e.g. comprises that a calling party CP is identified uniquely or as a part of a group and therefore is interviewed in a certain way.

When the interviewing session is terminated the calling party feedback CPF is stored in storage means SM, 3014 for further processing. The incoming call is also terminated in step 35.

If the calling party CP hangs up in one of the steps described above, the incoming and further call is terminated 35 and temporal data is stored in the storage means SM, 3014 may preferably be erased.

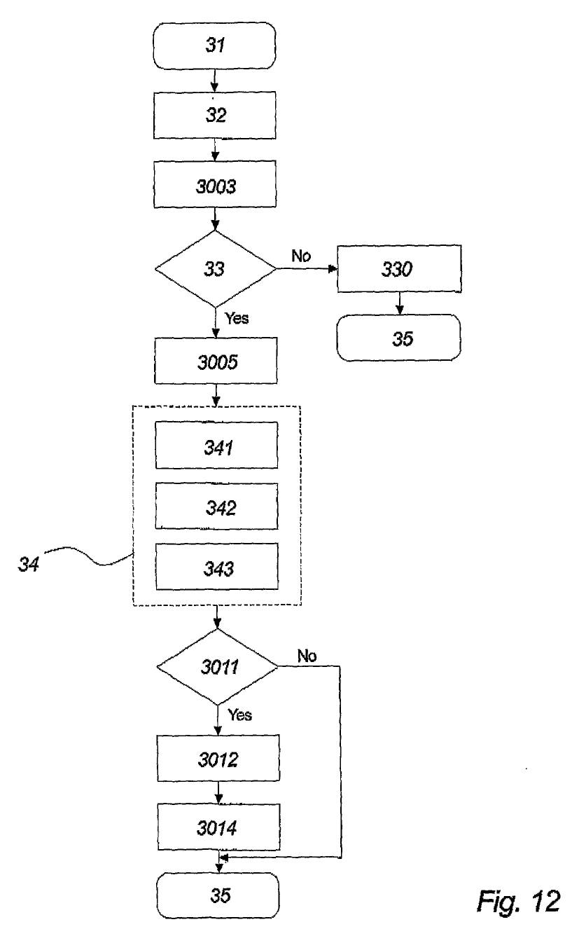

FIG. 12 illustrates a more detailed flowchart of a call sequence than illustrated in FIG. 11. In the following the new steps in the flowchart are described. When the incoming call is detected by the local switch 32, the call may in one embodiment of the invention be sent to a recruiting arrangement RA 3003 e.g. a hunt group or a CTI. If the call is a recruited incoming call RIC, the calling party can accept participation in an interview in step 33. If the calling party rejects the interview in step 33, the call is sent to the local recipient LR1, LR2, LR3, LRn, 330 as if the call was not recruited, or the call may be further processed as a normal recruited farther call FC, without performing the interview, where after the call is terminated at hang-up in step 35.

If the calling party CP, in step 33, accepts the recruitment and thereby is a recruited incoming call RIC 34, the call is routed to the survey system SS, 3005. From the survey system SS, 3005 the incoming call's voice layer is linked 342 to a further call 341 as described above in FIG. 11. The rest of the flow is as described above in FIG. 11.

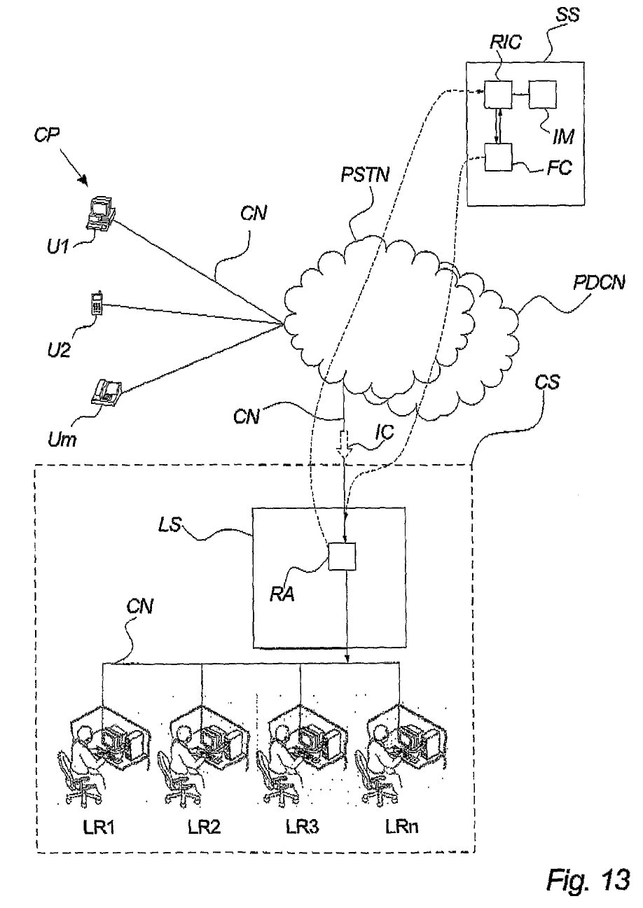

FIG. 13 illustrates another embodiment of the system for acquiring calling party feedback CPF. This figure is a modification of FIG. 7, wherein the survey system SS is moved outside the company sphere CS to visualize another embodiment of the invention. Furthermore, the content of the local switch LS is modified.

In this particular embodiment of the invention, a remote installation of the survey system SS is visualized.

The local switch LS may in this particular embodiment of the invention comprise any possible routing means and any recruitment arrangements RA. The recruited call is transmitted via PSTN, PDCN, or any wired or wireless data transfer arrangement to the remote survey system SS. The further call FC is established and transmitted via PSTN, PDCN, or any wired or wireless data transfer medium back to the local switch LS in the company sphere CS.

In this present embodiment of the invention, an arrangement is made in the remote survey system RSS or in the local switch LS which assures that further calls FC are not recruited in the recruiting arrangement RA.

In an advantageous embodiment of the invention, the further call FC is subject to utilizing the receipt of call descriptive data CDD on the basis of signaling in the local switch LS e.g. PBX. This is a fact in the survey system SS as well as in the remote survey system RSS.

1-76. (canceled)

77. A survey system (SS) comprising
a survey system input (SSI) for input of call descriptive data (CDD) from a local switch (LS),
interviewing means (IM) providing feedback from calling parties (CPF) routed through said local switch (LS),
correlation means (CM) producing correlation results (CR) on the basis of correlating said call descriptive data (CDD) and said calling party feedback (CPF).

78. A survey system (SS) according to claim 77,
wherein said correlation results (CR) comprise customer satisfaction data produced on the basis of a correlation of said call descriptive data (CDD) and calling party feedback (CPF).

79. A survey system (SS) according to claim 77, wherein said survey system (SS) is a stand-alone arrangement.

80. A survey system (SS) according to claim 77, wherein said interviewing means (IM) is situated externally with respect to the local switch (LS).

81. A survey system (SS) according to claim 77, wherein said interviewing means (IM) comprises an IVR (IVR: interactive voice response).

82. A survey system (SS) according to claim 77, wherein said call descriptive data (CDD) comprises information of the routing through the system.

83. A survey system (SS) according to claim 77, wherein said call descriptive data (CDD) comprises data extracted from CDR records.

84. A survey system (SS) according to claim 77, wherein said survey system (SS) further comprises or interacts with a recruiting arrangement (RA), said recruiting arrangement RA is recruiting a subset of the incoming calls (RIC) to said survey system (SS).

85. A survey system (SS) according to claim 84, wherein said system detects a recruited incoming call (RIC) from a calling party (CP) to a local recipient (LR) via a local switch (LS) and establishes a further call (FC) via the local switch to said local recipient (LR) and connects said further call (FC) to said recruited incoming call (RIC) to establish a call from the calling party (CP) to the recipient.

86. A survey system (SS) according to claim 85, wherein session data is established on the basis of said further call (FC) by the survey system (SS) and stored as partial or complete call descriptive data (CDD).

87. A survey system (SS) according to claim 77, wherein said correlation results (CR) are established on the basis of said correlation means (CM) which includes a matching process that performs a matching of said call descriptive data (CDD) received in said survey system input (SSI) and said session data.

88. A survey system (SS) according to claim 77, wherein said system further comprises an exporting arrangement (EA) exporting call descriptive data (CDD) from said local switch (LS) to said survey system (SS).

89. A system for acquiring feedback (CPF) from a calling party (CP),
said system comprising
a survey system (SS) according to claim 77,
said system further comprising
a local switch (LS) routing an incoming call (IC) from a calling party (CP) to one or more recipients (LR1, LR2, LR3, . . . LRn).

90. A system for acquiring feedback (CPF) from a calling party according to claim 89, wherein routing of said incoming call (IC) to said to one or more recipients (LR1, LR2, LR3, . . . , LRn) in said system is performed by means of said local switch (LS) comprising at least one of the following: PBX (Private Branch Exchange), CTI (Computer Telephony integration), IPPBX (Internet Protocol Private Branch eXchange), and
wherein said one or more recipients (LR1, LR2, LR3, . . . , LRn) are connected to said local switch (LS) in one of the following ways: via a communication network (CN), via a packet-based digital network or via a circuit switched network as PSTN (Public Switched Telephone Network).

91. Use of call descriptive data (CDD) exported from a local switch (LS) for establishment of correlation results (CR) on the basis of a correlation between calling party feedback (CPF) and said call descriptive data (CDD).

92. Method of acquiring feedback from a calling party in a system comprising
a local switch (LS) routing an incoming call (IC) from a calling party (CP) to one or more recipients (LR1, LR2, LR3, . . . , LRn), and
interviewing means (IM) obtaining feedback (CPF) from calling party on the basis of an interactive interview with said calling party (CP),
said method comprising the steps of
exporting call descriptive data (CDD) from said local switch (LS) describing calls routed through said local switch (LS) and
correlating said feedback (CPF) with said call descriptive data (CDD) into correlation results (CR).
